(19) United States
(12) Patent Application Publication
(10) Pub. No.: US 2004/0152590 A1
(43) Pub. Date: Aug. 5, 2004

(54) Ziegler natra catalyst for the polymerization of olefins

(76) Inventors: Gianni Collina, Ferrara (IT); Diego Brita, Ferrara (IT)

Correspondence Address: BASELL USA INC., INTELLECTUAL PROPERTY, 912 APPLETON ROAD, ELKTON, MD, 21921, US

(21) Appl. No.: 10/468,640

(22) PCT Filed: Dec. 13, 2002
(86) PCT No.: PCT/EP02/14252

(30) Foreign Application Priority Data
Dec. 24, 2001 (EP) 012050910

(51) Int. Cl. B01J 31/00; C08F 4/44

(52) U.S. Cl. 502/128; 526/124.3; 502/103

(57) ABSTRACT

Catalyst for the polymerization of olefins CH₂═CHR, wherein R is hydrogen or a hydrocarbon radical having 1-12 carbon atoms, comprising (I) a solid catalyst component comprising Mg, Ti, Cl, and OR groups, where R is a C1-C10 alkyl group optionally containing heteroatoms, in which the Ti/Mg weight radio is from 2 to 6.5 the Cl/Ti weight ratio is from 1.5 to 3.5 to and the OR/Ti weight ratio is from 0.7 to 2.5 and at least 50% of the titanium atoms are in a valence state lower than 4 and (II) an alkyaluminum halide as cocatalyst. The said catalysts allow the preparation of ethylene copolymers with a low content of xylene soluble fractions.

The present invention relates to catalysts for the polymerization of olefins CH₂═CHR, wherein R is hydrogen or a hydrocarbon radical having 1-12 carbon atoms. In particular, the present invention relates to a catalyst comprising (I) a solid catalyst component based on Mg, Ti, halogen and OR groups, and (II) halogenated aluminum alkyls as cocatalyst. This catalyst is particularly suitable for the preparation of copolymers of ethylene with α-olefins due to its capability of randomly distribute the α-olefins along the polymer chain.

Accordingly, another object of the present invention is the use of said catalysts in a process for the copolymerization of olefins in order to produce ethylene/α-olefin copolymers.

Linear low-density polyethylene (LLDPE) is one of the most important products in the polyolefin field. Due to its characteristics, it finds application in many sectors and in particular in the field of wrapping and packaging of goods where, for example, the use of stretchable films based on LLDPE constitutes an application of significant commercial importance. LLDPE is commercially produced with liquid phase processes (solution or slurry) or via the more economical gas-phase process. Both processes involve the widespread use of Ziegler-Natta catalysts that are generally formed by the reaction of a solid catalyst component, comprising a titanium compound, deposited on a Mg containing support, with an alkylaluminium compound.

As far as the preparation of LLDPE is concerned, said catalysts are required to show good comonomer distribution suitably coupled with high yields.

The good comonomer distribution ensures the achievement of an ethylene copolymer which has a density sufficiently lower with respect to HDPE while at the same is not affected by too high values of fractions soluble in hydrocarbon solvent like hexane or xylene which worsen certain properties of the said copolymers, and in particular tend to increase the blocking phenomenon observed for example in the rolls of LLDPE film.

U.S. Pat. No. 4,218,339 discloses catalyst components for the polymerization of olefins obtained by the reacting a Mg compound, preferably a Mg halide with an oxygen containing compound of a metal M selected from Ti, V or Zr and then by contacting the so obtained product with a compound, or a mixture of compounds in order to explicate on said reaction product an halogenating and reducing action. The said catalyst components are transformed in active catalyst for the polymerization of olefins by reaction with aluminum trialkyls in particular triisobutyl aluminum. Although generically stated that the catalysts are active also in the copolymerization of ethylene with alpha olefins, their use and effectiveness in this type of polymerization is not reported.

EP 155682 discloses the use of the same kind of catalyst components in the preparation of LLDPE polymers. From the comparison of Example 11 and comparative example 7 it is apparent that the said catalyst components are endowed with a good capability of distributing the comonomer only when a specific nitrogen containing external donor is used together with the aluminum trialkyl. The presence of nitrogen containing external donor has two negative effects: it may decrease the activity of the catalyst and increase the cost of the catalyst. No mention is made of the possibility of using a halogenated aluminum alkyl as cocatalyst.

The applicant has now found catalysts for the polymerization of olefins that are particularly suitable for the preparation of LLDPE polymers comprising (I) a solid catalyst component comprising Mg, Ti, Cl, and OR groups, where R is a C1-C10 alkyl group optionally containing heteroatoms, in which the Ti/Mg weight ratio is from 2 to 6.5 the Cl/Ti weight ratio is from 1.5 to 3.5 and the OR/Ti weight ratio is from 0.7 to 2.5 and at least 50% of the titanium atoms is in a valence state lower than 4 and (II) an alkyaluminum halide as cocatalyst. The alkylaluminum halide is suitably selected among alkylaluminum chlorides and in particular among diethylaluminum chloride, diisobutylaluminum chloride, Al-sesquichloride and dimethylaluminum chloride. Dimethylaluminum chloride is especially preferred. In the solid catalyst component (I) the Ti/Mg weight ratio is preferably from 2.25 to 6 and more preferably from 2.4 to 5.5 the Cl/Ti weight ratio is preferably from 1.75 to 3.25 and preferably from 2 to 3, the OR/Ti weight ratio is preferably from 0.8 to 2.25 and more preferably from 1 to 2; it is moreover preferred that at least 70%, and more preferably 80%, of the titanium atoms is in a valence state lower than 4.

The solid catalyst component (I) can be prepared according to the general disclosure of U.S. Pat. No. 4,218,339. In particular it can be obtained by reacting:

(A) a magnesium compound of formula XₙM_{g}(OR₁)₂₋ₙ, wherein X is a halogen atom, hydroxyl group or an alkyl, aryl or cycloalkyl radical containing 1-20 carbon atoms; R′ is an alkyl, aryl or cycloalkyl radical containing 1-20 carbon atoms, or a —COR′ radical in which R′ has the same meaning as R; 0≦n≦2, or products of reaction of said compounds with electron-donor compounds; with

(B) a compound of Ti, containing at least two titaniumoxygen bonds Ti-OR² wherein R² is an alkyl. aryl or cycloalkyl radical having 1-20 carbon atoms, and

(C) a compound or a mixture of compounds, other than the aluminium halides, capable of exerting a halogenating and a reducing action on compound (B), i.e. capable of substituting in the compound (B) at least one group —OR² with a halogen atom and of reducing the titanium of compound (B) to a lower valence. As mentioned above a mixture of a halogenating compound with a compound having a reducing ability can be used.

Examples of (A) compounds are the Mg dihalides, the Mg mono-and dialcoholates, examples of which are Mg(OC₂H₅)₂, Mg(O-n-C₄H₉)₂, C₂H₅O—MgCl, n-C₄H₉O—MgCl, the Mg carboxylates such as Mg acetates. As Mg dihalides the following compounds can be employed MgCl₂, which is the preferred one, MgBr₂, MgI₂, MgCl₂.nR³OH (R³=alkyl group, n=1-6), for example MgCl₂₃C₂H₅OH, or MgCl₂.n H₂O (0≦n≦6), and adducts of MgCl₂ with electron donor compounds not containing active hydrogen atoms, like the esters of carboxylic acids, the ethers, ketones or amines.

Example of components (B) are: Ti(OC₂H₅)₄, Ti(O-n-C₄H₉)₄, Ti(O-i-C₃H₇)₄, Ti(OC₆H₅)₄, Ti-triacetylacetonate Ti (OCH₃)₂ (OC₂H₅)₂. However, haloalcoholates can be also used, as for instance (n-C₄H₉O)₃TiCl.

Examples of compounds or mixture of components (C) comprise a halogen-containing, preferably a chlorine-containing compounds, capable of substituting a halogen atom for at least one group —OR² in component (B). Specific examples of such compounds include organic acid halides R⁴COX (in which X is halogen, preferably chlorine, and R⁴ is an aliphatic or aromatic radical); hydrogen halides such as HCl, SOCl₂, COCl₂, TiCl₄, BCl₃, and others.

Particularly satisfactory results are achieved by using as halogenating agents halogen-containing silicon compounds or halogen and hydrogen-containing silicon compounds. The latter act as both reducing agents and halogenating agents. Specific examples of such silicon compounds include:

silicon halides having formula SiX₄₋ₙYₙ, in which X and Y represent halogen atoms, e.g., Cl and Br, and n is a number varying from zero to 3, inclusive as SiCI₄;

chlorosiloxanes of formula SiₙOₙ₋₁Cl₂ₙ₊₂, in which n is a number varying form 2 to 7 inclusive, e.g., Si₂OCl₆;

Halogenated polysilanes having formula SiₙX₂ₙ₊₂, wherein X is halogen and n is a number varying form 2 to 6, inclusive, for instance Si₄Cl₁₀;

Alkoxy-halogensilanes of formula Si(OR)₄₋ₙXₙ in which X is halogen, R is alkyl or aryl having 1 to 20 carbon atoms and n is a number from 1 to 3, inclusive, e.g., Si(OC₂H₅)Cl₃.

Halogensilanes having formula SiH₄₋ₙXₙ in which X is halogen and n is a number varying form 1 to 3, inclusive, e.g., SiHCl₃;

Alkyl-halogensilanes having formula RₙSiHₓX_{y} wherein R is an aliphatic or aromatic radical, X is halogen, n is a number from 1 to 3, inclusive, x is a number varying form zero to 2, inclusive, and y is a number varying form 1 to 3, inclusive, e.g., C₂H₅SiCl₃; CH₃SiCl₂H; (CH₃)₂SiCl₂;

Examples of agents having a reducing activity to be used as compound (C) include Na-alkyls, Li-alkyls, Zn-allyls, Mg-alkyls and corresponding aryl-derivatives, Grignard compounds of the type RMgX(R is an aliphatic or aromatic hydrocarbon radical; X is halogen), the Na+alcohol system, and furthermore NaH and LiH. Particularly effective as reducing agents are the polyhydrodiloxanes in which the monomer unit has the general formula

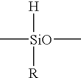

Wherein R is H, halogen, alkyl with 1 to 10 carbon atoms, aryl, alkoxyl, aryloxyl or carboxyl, and the polymerization grade ranges from 2 to 1,000, preferably from 3 to 100. Specific examples of such polyhydrosyloxanes include the compounds:

(CH₃)₃Si—O[(CH₃)HSiO]ₙ—Si(CH₃)₃, (CH₃HSiO)₄, (CH₃HSiO)₃, H₃Si—O—SiH₂—OSiH₃, phenylhydropolysiloxanes in which the hydrogen atoms can be partially replaced by methyl group.

Other silicon compounds useful as reducing agent in the practice of this invention are:

Silanes SiₙH₂ₙ₊₂, in which n is a number equal to or higher that 1, preferably equal to or higher than 3, e.g., Si₃H₈;

Polysilanes that contain the group (SIH)ₓ in which x≧2;

Alkyl or aryl silanes RₓSiH₄₋ₓ, in which R is alkyl or aryl and x is a number varying from 1 to 3, inclusive, e.g., (C₆H₅)₃SiH;

Alkoxy—or aryloxy—silanes (RO)ₓSiH₄₋ₓ, in which R is alkyl or aryl and x is a number varying for 1 to 3, inclusive, e.g., (C₂H₅O)₃SiH.

The new catalyst-forming components of the invention can be obtained by reacting (A) and (B) and (C) in an aliphatic or aromatic hydrocarbon diluent or in the absence of diluent. When at least one of the reagents is in the liquid state at the reaction temperature and pressure, the use of a solvent can be omitted.

(A) and (B) can be reacted preferably until a homogeneous product is obtained which is then reacted with component (C).

However, if (C) consists of a halogenating compound plus a reducing compound, the order of addition makes no difference: i.e., either the halogenating compound or the reducing compound can be reacted first. It is also possible to add the compounds simultaneously.

The reactions are conducted at a temperature ranging from −10° C. to +250° C., preferably from 20° C. to 200° C. The selection of the temperature depends also on the type of component (C), because the higher its reducing power, the lower the preferred reaction temperatures.

Since (C) is both a halogenating agent and a reducing agent, or it consists of a halogenating compound plus a reducing compound, the titanium, in the final catalyst-forming component is prevailingly in the trivalent state, provided that a sufficient quantity of reducing agent is used.

The component (I) can be used to prepare the catalyst system of the invention directly as obtained from its preparation process. Alternatively, it can be pre-polymerized before being used in the main polymerization process. This is particularly preferred when the main polymerization process is carried out in the gas phase. The prepolymerization can be carried out with any of the olefins CH₂═CHR, where R is H or a C1-C10 hydrocarbon group. In particular, it is especially preferred to pre-polymerize ethylene or mixtures thereof with one or more α-olefins, said mixtures containing up to 20% in moles of α-olefin, forming amounts of polymer from about 0.1 g per gram of solid component up to about 100 g per gram of solid catalyst component. The pre-polymerization step can be carried out at temperatures from 0 to 80° C., preferably from 5 to 50° C., in the liquid or gas phase. The co-catalyst can be the same as, or different from, the cocatalyst (II). Therefore it can be used an alumintumalkyl halide or the corresponding not halogenated ones such as aluminum triethyl, aluminum triisobutyl, aluminum tri-n-octyl etc. In a particular embodiment of the present invention, a halogenated aluminumalkyl compound is used also in the prepolymerization step. The pre-polymerization step can be performed in-line as a part of a continuous polymerization process or separately in a batch process. The batch pre-polymerization of the catalyst of the invention with ethylene in order to produce an amount of polymer ranging from 0.5 to 200 g per gram of catalyst component is particularly preferred. The prepolymerized catalyst component can also be subject to a further treatment with a titanium compound before being used in the main polymerization step. In this case the use of TiCl₄ is particularly preferred. The reaction with the Ti compound can be carried out by suspending the prepolymerized catalyst component in the liquid Ti compound optionally in mixture with a liquid diluent; the mixture is heated to 60-120° C. and kept at this temperature for 0.5-2 hours.

Examples of gas-phase processes wherein it is possible to use the catalysts of the invention are described in WO 92/21706, U.S. Pat. No. 5,733,987 and WO 93/03078. These processes comprise a pre-contact step of the catalyst components, a pre-polymerization step and a gas phase polymerization step in one or more reactors in a series of fluidized or mechanically stirred bed.

The catalysts of the present invention are particularly suitable for preparing linear low density polyethylenes (LLDPE, having a density lower than 0.940 g/cm³) and very-low-density and ultra-low-density polyethylenes (VLDPE and ULDPE, having a density lower than 0.920 g/cm³, to 0.880 g/cm³) consisting of copolymers of ethylene with one or more alpha-olefins having from 3 to 12 carbon atoms, having a mole content of units derived from ethylene of higher than 80%. However, they can also be used to prepare a broad range of polyolefin products including, for example, high density ethylene polymers (HDPE, having a density higher than 0.940 g/cm³), comprising ethylene homopolymers and copolymers of ethylene with alpha-olefins having 3-12 carbon atoms; elastomeric copolymers of ethylene and propylene and elastomeric terpolymers of ethylene and propylene with smaller proportions of a diene having a content by weight of units derived from ethylene of between about 30 and 70%; isotactic polypropylenes and crystalline copolymers of propylene and ethylene and/or other alpha-olefins having a content of units derived from propylene of higher than 85% by weight; impact resistant polymers of propylene obtained by sequential polymerization of propylene and mixtures of propylene with ethylene, containing up to 30% by weight of ethylene; copolymers of propylene and 1-butene having a number of units derived from 1-butene of between 10 and 40% by weight.

The following examples are given in order to further describe the present invention in a non-limiting manner.

Characterization

The properties are determined according to the following methods:

Melt Index: measured at 190° C. according to ASTM D-1238 condition “E” (load of 2.16 Kg) and “F” (load of 21.6 Kg);

Fraction soluble in xylene. The solubility in xylene at 25° C. was determined according to the following method: About 2.5 g of polymer and 250 ml of o-xylene were placed in a round-bottomed flask provided with cooler and a reflux condenser and kept under nitrogen. The mixture obtained was heated to 135° C. and was kept under stirring for about 60 minutes. The final solution was allowed to cool to 25° C. under continuous stirring, and was then filtered. The filtrate was then evaporated in a nitrogen flow at 140° C. to reach a constant weight. The content of said xylene-soluble fraction is expressed as a percentage of the original 2.5 grams.

Comonomer Content

1-Butene was determined via Infrared Spectrometry.

The α-olefins higher than 1-butene were determined via Infra-Red analysis.

Effective density: ASTM-D 1505

### EXAMPLES

### Example 1

Preparation of the Solid Component

Preparation of Solution A

MgCl₂ (69 g) and 510 ml of Ti(OBU)₄ are stirred in a flask under nitrogen at a temperature of 140° C. obtaining after 5 hours a complete dissolution of the MgCl₂.

In a 2 L reactor equipped with blase stirrer were introduced 660 ml of heptane and, at a temperature of 60° C., under stirring 225 ml of solution A prepared as described above. After that 165 ml of polymethylhydrosiloxane (PMHS) were added. After 10 minutes the mixture was cooled down to 50° C. At this point a first aliquot of SiCl₄ (20 ml) was added in 30 min while a second aliquot (155 ml) was added in the subsequent 30 min. The temperature was brought to 65° C. and left under stirring for two hours. After this period the solid was allowed to settle and the supernatant siphoned off. The solid obtained was washed three times with heptane at 60° C. and three times with heptane at room temperature.

The solid obtained had the following composition:

| | | |
|---|---|---|
| Ti (total) | 15.3 | wt. % |
| Ti red. | 13.6% | |
| Mg | 5 | wt. % |
| Cl | 36.3 | wt. % |
| Si | 4.5% | wt |
| —OBu | 22 | wt. % |

Preparation of the Pre-Polymer

The catalyst prepared above was prepolymerized in hexane slurry with ethylene in the presence of Dimethylaluminum chloride (DMAC) at a temperature of 0° C. for the time necessary to reach a prepolymer/catalyst weight ratio of about 1.

Ethylene Copolymerization

A 15.0 liter stainless-steel fluidized reactor equipped with gas-circulation system, cyclone separator, thermal exchanger, temperature and pressure indicator, feeding line for ethylene, propane, 1-butene and hydrogen was used. The gas-phase apparatus was purified by fluxing pure nitrogen at 40° C. for 12 hours and then was circulated a propane (10 bar, partial pressure) mixture containing 1.5 g of TEAL at 80° C. for 30 minutes. It was then depressurized and the reactor washed with pure propane, heated to 75° C. and finally loaded with propane (2 bar partial pressure), 1-butene, ethylene (7.1 bar, partial pressure) and hydrogen (2.1 bar, partial pressure).

The prepolymer as prepared above, and the aluminum alkyl halide reported in table 1 were injected into the gas-phase reactor by using a propane overpressure (1 bar increase in the gas-phase reactor). The final pressure, in the fluidized reactor, was maintained constant during the polymerization at 75° C. for 180 minutes by feeding a 10 wt. % 1-butene/ethylene mixture.

At the end, the reactor was depressurised and the temperature was dropped to 30° C. The collected polymer was dried at 70° C. under a nitrogen flow and weighted.

The polymer characteristics are collected in table 1.

Examples 2-3 and comparison Example 1

The polymerization was carried out according to the same procedure of example 1 with the difference that a different cocatalyst was used (Ex.3 and Comp. Ex. 1) or a polymer with a lower butene-1 content was produced (Ex. 2). The polymer characteristics are shown in table 1.

TABLE 1

| | Ex. 1 | Ex. 2 | Ex. 3 | Comp. Ex. 1 |
|---|---|---|---|---|
| Cocat | DMAC | DMAC | DEAC | TEAL |
| MIE | 0.87 | 0.8 | 1.09 | 0.87 |
| % wt C₄⁻ | 10.5 | 9.9 | 10.4 | 10.8 |
| Density | 0.916 | 0.917 | 0.918 | 0.917 |
| Solubles % Wt | 11 | 8.8 | 11.5 | 14.9 |

1. Catalyst for the (co)polymerization of olefins CH₂═CHR, wherein R is hydrogen or a hydrocarbon radical having 1-12 carbon atoms, comprising (I) a solid catalyst component comprising Mg, Ti, Cl, and OR groups, where R is a C₁-C₁₀ alkyl group optionally containing heteroatoms, in which the Ti/Mg weight ratio is from 2 to 6.5 the Cl/Ti weight ratio is from 1.5 to 3.5 and the OR/Ti weight ratio is from 0.7 to 2.5 and at least 50% of the titanium atoms are in a valence state lower than 4 and (II) an alkyaluminum halide as cocatalyst.

2. Catalyst according to claim 1 in which the alkylaluminum halide is an alkylaluminum chloride.

3. Catalyst according to claim 2 in which the alkylaluminum halide is diethylaluminum chloride, diisobutylalumunum chloride, Al-sesquichloride or dimethylaluminum chloride.

4. Catalyst according to claim 1 or 3 in which the Ti/Mg weight ratio is from 2.25 to 6, the Cl/Ti weight ratio is from 1.75 to 3.25, the OR/Ti weight ratio is from 0.8 to 2.25.

5. Catalyst according to claim 1 in which at least 70% of the titanium atoms are in a valence state lower than 4.

6. Catalyst according to claim 4 in which the Ti/Mg weight ratio is from 2.4 to 5.5, the Cl/Ti weight ratio is from 2 to 3 and the OR/Ti weight ratio is from 1 to 2.

7. Catalyst according to claim 5 in which at least 80% of the titanium atoms are in a valence state lower than 4.

8. Catalyst according to claim 1 in which the solid catalyst component (I) is prepolymerized with one or more of the olefins CH₂═CHR, where R is H or a C1-C12 hydrocarbon group.

9. Catalyst according to claim 8 prepolymerized with one or more olefins up to forming amounts of polymer from about 0.1 g per gram of solid component to about 100 g per gram of solid catalyst component.

10. Process for the polymerization of olefins CH₂═CHR, where R is H or a C1-C10 hydrocarbon group, carried out in the presence of the catalyst according to any one of the claims 1-9.
